(19) United States
(12) Patent Application Publication
(10) Pub. No.: US 2009/0170550 A1
(43) Pub. Date: Jul. 2, 2009

(54) Method and Apparatus for Portable Phone Based Noise Cancellation

(76) Inventor: Denis J. FOLEY, Shrewsbury, MA (US)

Correspondence Address: QUALCOMM INCORPORATED, 5775 MOREHOUSE DR., SAN DIEGO, CA, 92121, US

(21) Appl. No.: 11/967,610

(22) Filed: Dec. 31, 2007

(51) Int. Cl. H04M 1/00

(52) U.S. Cl. 455/550.1

(57) ABSTRACT

A system includes a mobile phone configured to create an inverted signal having characteristics inverse to identified noise components of a detected audio signal. The mobile phone is configured to provide the inverted signal as an output to a headphone, such that a combination of the identified noise components and the inverted signal substantially cancel each other out.

### BACKGROUND OF THE INVENTION

1. Field of the Invention

The present invention generally relates to noise cancellation systems. More particularly, the present invention relates to noise cancellation in devices, such as mobile phones.

2. Related Art

A variety of noise cancellation (active) headphones are commercially available through companies such as Bose Corporation, Panasonic Corporation, and Sony Corporation of America. Use of the term active implies use of an audio pick-up mechanism, such as a microphone. These traditional noise cancellation headphones are designed to reduce or eliminate environmental sounds, such as wind, airplane noise, automobile engine noise, and many other undesirable sounds. These headphones operate by placing a microphone within the headphones, near the ear, to sense the undesirable environmental sounds.

Electronic processing circuitry, which can also be positioned within the headphones, receives and analyzes the sounds detected by the microphone and generates a corrected (i.e. inverted) signal to cancel out the undesirable environmental sounds. As understood by those of skill in the art, this electronic processing circuitry can be digital or analog in nature.

The inverted signal is mixed with an audio stream that is to be heard through the headphones by a listener. The inverted signal cancels out the undesirable sounds, ultimately reducing the noise level within the enclosed volume of the headphones. By reducing the noise level within the headphones, it becomes possible, for example, to enjoy music without raising the volume of the music unreasonably high. The headphones can also be used to produce quiter environments in which, for example, a passenger can sleep in an otherwise noisy environment, such as on an airplane.

These commercially available heaphones, however, are quite expensive. This expense becomes more apparent when compared to the virtually disposable generic headphones typically used with multimedia devices such as Moving Picture Experts Group Layer 3 (MP3) players or MP3 enabled cell phones (e.g. the ubiquitous bud earphones used with the ipod).

What is needed, therefore, is a more affordable approach to provide the benefits of noise cancellation headphone technology using inexpensive generic headphones.

### BRIEF SUMMARY OF THE INVENTION

Consistent with the principles of the present invention as embodied and broadly described herein, the present invention includes a mobile phone configured to create an inverted signal having characteristics inverse to identified noise components of a detected audio signal. The mobile phone is configured to provide the inverted signal as an output to a headphone, such that a combination of the identified noise components and the inverted signal substantially cancel each other out.

Current portable phone technology allows for audio techniques such as echo or wind noise reduction. The present invention extends the use of these currently available audio techniques to provide active noise cancellation using generic passive headphones.

Further embodiments, features, and advantages of the present invention, as well as the structure and operation of the various embodiments of the present invention, are described in detail below with reference to the accompanying drawings.

### BRIEF DESCRIPTION OF THE DRAWINGS

The accompanying drawings, which are incorporated in and constitute part of the specification, illustrate embodiments of the invention and, together with the general description given above and the detailed description of the embodiment given below, serve to explain the principles of the present invention. In the drawings:

FIG. 1 is an illustration of conventional noise cancellation headphones;

FIG. 2 is an exemplary block diagram illustration of traditional mixing/analyzing application specific integrated circuits (ASICs) included within the headphones shown in FIG. 1;

FIG. 3 is an illustration of an exemplary applications processor in accordance with an embodiment of the present invention; and

FIG. 4 is an illustration of an MP3 enabled phone and headphones configured in accordance with the present invention.

### DETAILED DESCRIPTION OF THE INVENTION

The following detailed description of the present invention refers to the accompanying drawings that illustrate exemplary embodiments consistent with this invention. Other embodiments are possible, and modifications may be made to the embodiments within the spirit and scope of the invention. Therefore, the detailed description is not meant to limit the invention. Rather, the scope of the invention is defined by the appended claims.

It would be apparent to one of skill in the art that the present invention, as described below, may be implemented in many different embodiments of software, hardware, firmware, and/or the entities illustrated in the figures. Any actual software code with the specialized control of hardware to implement the present invention is not limiting of the present invention. Thus, the operational behavior of the present invention will be described with the understanding that modifications and variations of the embodiments are possible, given the level of detail presented herein.

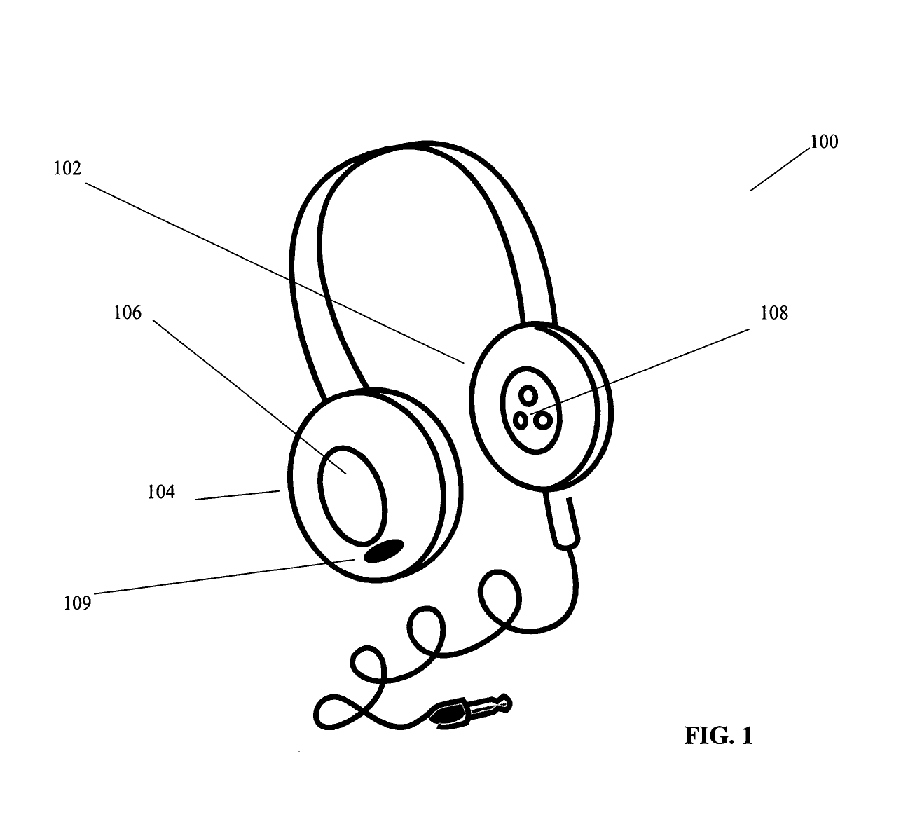

FIG. 1 is an illustration of conventional noise cancellation headphones 100. The conventional noise cancellation headphones 100 include a left ear portion 102 and a right ear portion 104. As noted above, the headphones 100 also include a microphone 109 to provide active pick-up, along with electronic processing circuitry (not shown).

The microphone 109 detects a noise signal. The electronic processing circuitry analyzes the received noise signal detected by the microphone 109. The processing circuitry quantifies amplitude and spectral composition of the detected noise signal A correction module, within the processing circuitry, generates a signal which cancels the detected noise signal (essentially an inverse of the detected noise signal) to eliminate unwanted environmental noises. Presenting this inverted signal to the listener has the effect of cancelling the noise signal and results in a a relatively noise free environment within enclosed areas 106 and 108 of the headphones 100.

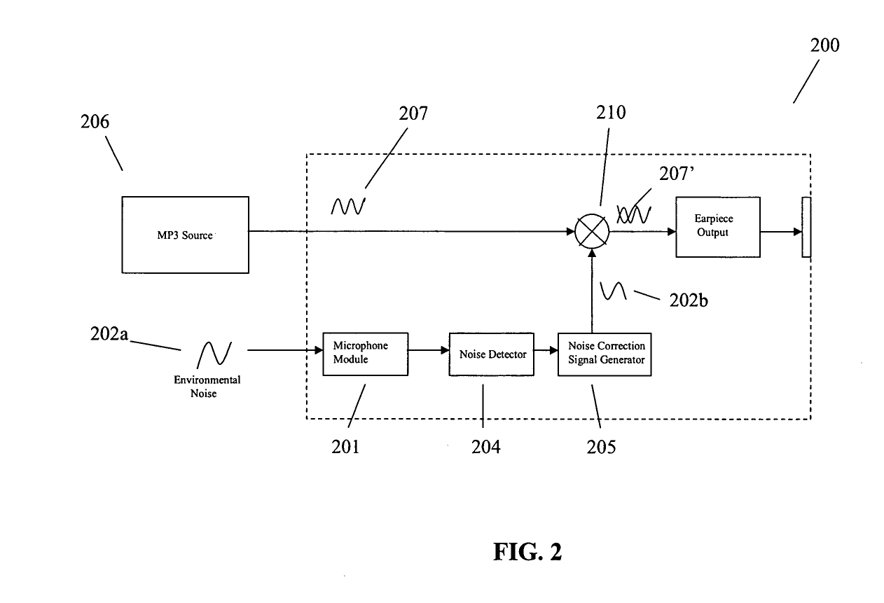

FIG. 2 is a block diagram illustration 200 of generic features included within the headphones 100 shown in FIG. 1. An input music source could be the output of a CD player, an MP3 player, or some other music source. Further, the input signal could be an analog input, a digital bit stream, or some other digital representation of the music signal.

The block diagram illustration 200 includes a microphone module 201 configured to receive a signal 202a indicative of environmental noise, such as an airplane, stadium crowd, wind, or some other noise. A noise detector and analysis circuit 204 receives and characterizes the noise signal output from the microphone module 201. A noise correction signal generator module 205 receives data output from the noise detector 204 and creates a cancellation signal 202b which is essentially an inverted version of the original noise signal 202a. The inverted signal 202b is mixed with a desirable audio signal 207 output from MP3 source 206 to create a combined signal 207′. This combined signal 207′ is presented to the listener.

The listener is presented with the combined signal 207′ and the original noise signal 202a. The combined signal 207′ essentially cancels out the noise signal 202a. The result of this cancellation is that the listener experiences only the desirable audio signal 207.

In the traditional noise cancellation headphones, such as the headphones 100, an audio mixing/analyzing circuit is provided within the headphones to perform noise cancellation. The inclusion and packaging of such a circuit is a substantial factor in the high cost of these traditional active headphones.

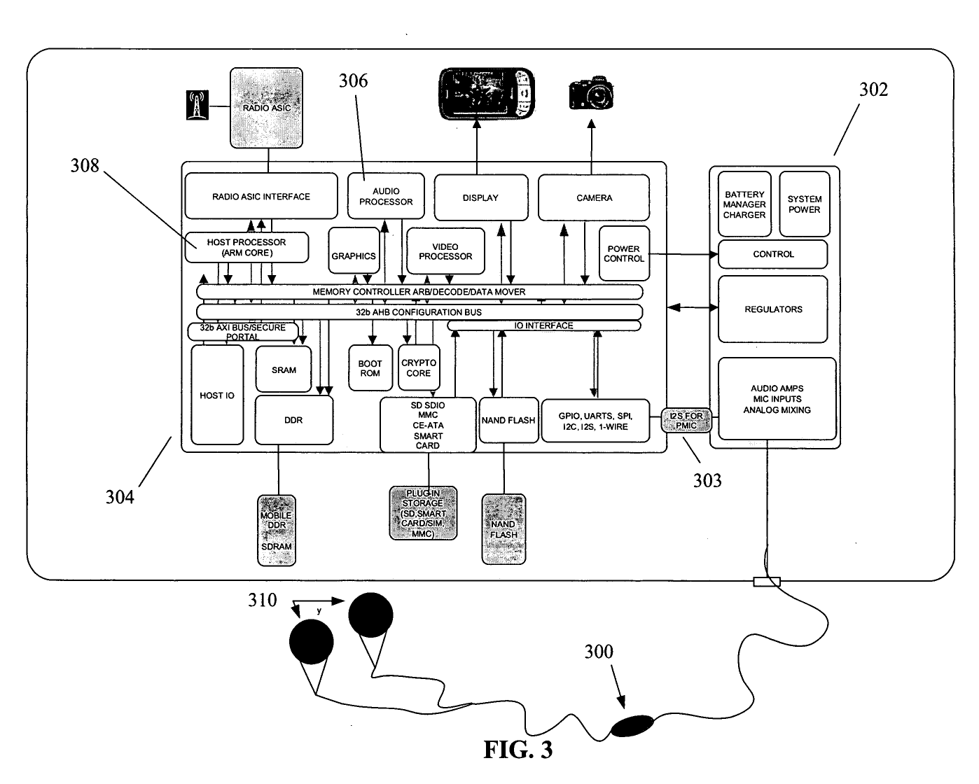

Mobile phones, however, include their own active pick-up mechanism in the form of a microphone. They also include advanced audio processing capabilities, in hardware, software, or both, capable of performing the noise detection/analysis/correction signal generation function. In other words, a mobile phone (such as a standard MP3 enabled mobile phone) can be extended to include the capabilities to detect and process an incoming noise signal, identify the noise sources, and create the inverse signals to cancel these sources. Such mixing/analyzing capabilities are well known to those of skill in the art and are included, for example, in the Imageon Applications processor, available from Advanced Micro Devices (AMD), shown at FIG. 3.

More specifically, FIG. 3 is an illustration of the exemplary Imageon Applications processor noted above. In FIG. 3, an audio signal (e.g., voice+noise or just noise) is picked up by a microphone 300. This audio signal is fed through (in this case) an audio/power management chip 302. The audio/power management chip 302 digitizes the received signal and forwards it over an 12S (Inter IC Sound) interface 303 to applications processor 304.

A digitized signal output from the audio/power management chip 302 is processed by a combination of an audio processor 306 and a host processor 308 to identify the noise component mentioned above. The audio processor 306 can then generate the inverse signal and digitally mix it with a desirable audio stream (for example a decoded MP3 music stream). The mixed audio output is forwarded back to the audio/power management chip 302 for playback through bud earphones 310. The noise and inverse noise signals cancel and the desirable audio output is audible to the listener.

Applications processors, such as the Imageon Applications processor 304 above, are included in MP3 players and mobile phones. By performing the noise cancellation processing internal to the MP3 player or mobile phone, the benefits of noise cancellation technology can be experienced with the use of much cheaper (passive) generic headphones, such as the bud earphones 310.

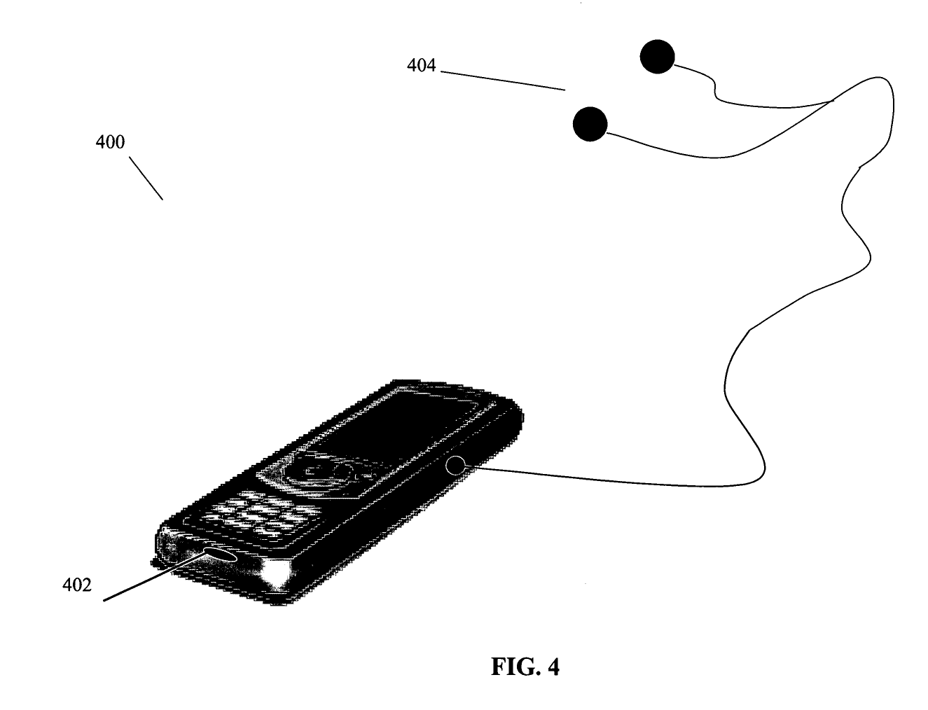

FIG. 4 is an exemplary illustration of a standard MP3 enabled mobile phone 400 constructed in accordance with an embodiment of the present invention. The mobile phone 400 can include, for example, a standard multi-media processor, such as the Imageon Applications processor 304 noted above, to perform the noise cancellation functions.

As shown in FIG. 4, the mobile phone 400 also includes its own active pick-up mechanism in the form of a microphone 402. Since the noise cancellation processing functions are embedded within the mobile phone 400, the benefits of noise cancellation can be experienced by the listener using inexpensive generic headphones 404.

### CONCLUSION

The present invention has been described above with the aid of functional building blocks illustrating the performance of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What we claim is:

1. A device, comprising:
a mobile phone configured to create an inverted signal having characteristics inverse to identified noise components of a detected audio signal;
wherein the mobile phone is configured to provide the inverted signal as an output to a headphone.

2. The device of claim 1, wherein a combination of the identified noise components and the inverted signal substantially cancel each other out.

3. The device of claim 1, further comprising a headphone configured for electrical coupling to the mobile phone and configured to receive the inverted signal as an input.

4. The device of claim 1, wherein the mobile phone is configured to detect and analyze the audio signal.

5. The device of claim 1, wherein the mobile phone is configured to facilitate activation of the inverted signal by a listener during playback of a desirable information signal.

6. The device of claim 1, wherein the creation of the inverted signal and outputting thereof, are representative of a noise cancellation feature; and
wherein the mobile phone is configured for activation of the noise cancellation feature by a listener.

7. The device of claim 6, wherein the noise cancellation feature is configured for activation by a listener during playback of a desirable information signal.

8. The device of claim 2, wherein the cancellation occurs within an enclosure of the headphone.

9. The device of claim 1, wherein the headphone receives the detected audio signal and a desirable information signal when coupled to the mobile phone; and
wherein the inverted signal is mixed with the information signal such that the playback of the mixed signal results in the cancellation of the detected audio signal resulting in the listener hearing only the desirable information signal.

10. The device of claim 9, wherein the audio signal is representative of noise.

11. The device of claim 1, wherein the headphones are devoid of an active pick-up mechanism.

12. A method for providing noise cancellation within a mobile phone, comprising:
creating an inverted signal having characteristics inverse to identified noise components of a detected audio signal; and
providing the inverted signal as an output to a headphone.

13. The method of claim 12, wherein a combination of the identified noise components and the inverted signal substantially cancel each other out.

14. The method of claim 12, further comprising detecting and analyzing the audio signal.

15. The method of claim 12, wherein the inverted signal is configured for activation by a listener during playback of an audio signal

16. A method of playing back an audio file on a mobile phone, comprising:
detecting an audio signal;
combining an inverted version of the detected audio signal with an output signal generated from the audio file; and
producing the combined signal as an output.

17. The method of claim 14, wherein the audio file is at least one of a streaming audio file and stored audio files.
